(19) United States
(12) Patent Application Publication
(10) Pub. No.: US 2019/0222539 A1
(43) Pub. Date: Jul. 18, 2019

(54) Network System

(71) Applicant: Marc Gittleman, Altadena, CA (US)

(72) Inventor: Marc Gittleman, Altadena, CA (US)

(73) Assignee: 5x5 Industries, LLC, Los Angeles, CA (US)

(21) Appl. No.: 15/691,743

(22) Filed: Aug. 31, 2017

Related U.S. Application Data
(60) Provisional application No. 62/382,214, filed on Aug. 31, 2016.

(51) Int. Cl. H04L 12/931; H04L 12/46

(52) U.S. Cl. CPC H04L 49/354; H04L 49/70; H04L 12/4641; H04L 49/351

(57) ABSTRACT

A network with wireless capability comprising a service provider network communicatively coupled to an access-layer switch and a plurality of access points; a customer network system communicatively coupled to the access-layer switch provided by the Service Provider; and a plurality of access points wherein the access points are capable of passing traffic from the customer network through the service providers' network to the customers' network devices.

### RELATED APPLICATIONS

The present application claims priority to U.S. Provisional Application No. 62/382,214 filed on Aug. 31, 2016.

### BACKGROUND

The inventions outlined, described, illustrated, and otherwise covered in this application create novel systems and methods for implementation of a wired and/or wireless network.

Conventional virtual local area networks (“VLANs”) were first developed as a technology to divide local area networks (“LANs”) into logical segments for performance and privacy reasons. The IEEE 802.1Q and 802.1p standards provide the specification for conventional VLAN behavior. More recently, wide are network (“WAN”) and metropolitan area network (“MAN”) service providers have extended the VLAN technology as a means to provide transparent LAN services (“TLS”) between remote sites among customers.

Current Ethernet LAN variants have rigid architecture. Once attached or connected, a device can communicate freely with other attached devices. If a wireless device that is connected to a VLAN through an wireless access point leaves the wireless access point's reception area, it must re-establish communications. This is true even if it never leaves the overall LAN reception area, i.e., the area covered by all connected access points, and even if it remains in the reception area of another connected access point. Beyond the wireless LAN coverage area, the wireless device must find some other way to connect, either wired (for example with a modem) or wirelessly.

There currently is not a system that can adequately provide customers and tenants with their own secure private Wi-Fi network outside of their rented, owned, or otherwise permanently or temporarily occupied space, throughout a property, select common areas, restaurants and other amenities without requiring a VPN or other layer solution. Therefore, there is a need in the art to solve the above limitations.

### SUMMARY

Disclosed herein is a network system that solves the above limitation in the art. The system is a network with wireless capability comprising a service provider network communicatively coupled to an access-layer switch and a plurality of access points; a customer network system communicatively coupled to the access-layer switch provided by the Service Provider; and a plurality of access points wherein the access points are capable of passing traffic from the customer network through the service providers' network to the customers' network devices. The system facilitates communications from the multiple network systems on the customer side into communications for delivery over a service provider network with persistent connectivity on the customer network.

Furthermore, the system comprises a customer and network service provider. In one embodiment, the access points are wireless networks. The customer may connect to the service provider at any layer in the network topology including but not limited the access-layer switch, edge-layer switch, the core switch, or core router of the service provider.

The access-layer switch can be employed in any environment including but not limited to a single tenant, multi-tenant or multi-dwelling complex. In the preferred embodiment, the customer network systems are VLAN network segments; however, the present invention is not limited to VLAN network segments.

In the preferred embodiment, the VLAN ID on the customer side remains intact during translation. Alternatively, the VLAN ID on the customer side may also undergo a transformation to help determine the particular VLAN ID to be used when the frame is transmitted over the service provider network.

### DRAWINGS

These and other features, aspects and advantages of the present invention will become better understood with regard to the following description, appended claims, and accompanying FIGURES where:

FIG. 1 is a network diagram illustrating an example of wide area network topology according to one embodiment of the present invention.

### DETAILED DESCRIPTION

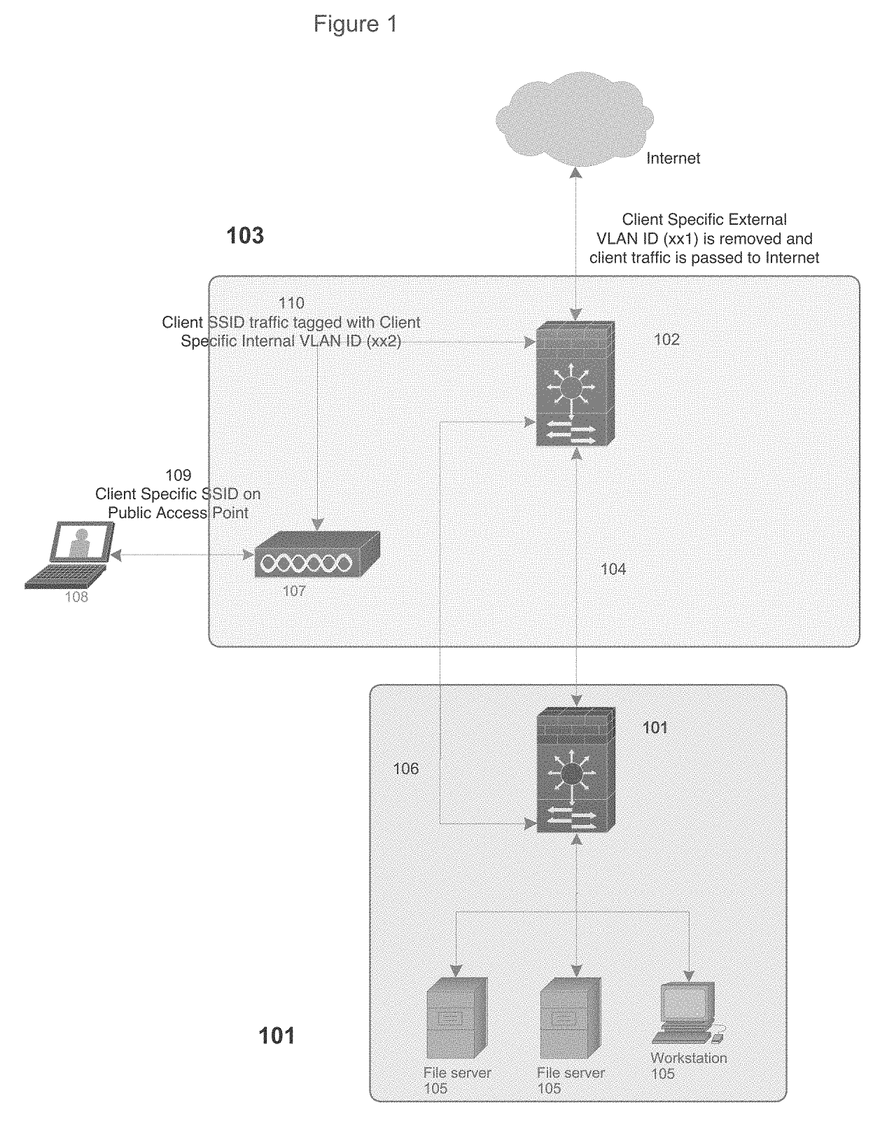

FIG. 1 is a network diagram illustrating an example wide area network topology according to an embodiment of the present invention. In the illustrated embodiment, the system comprises a plurality of customer side network systems 101. Customer side network systems 101 may comprise one or multiple distinct customer side network systems 101. The network system 101 may provide the following but not limited to: internet access, layer 2 access, routing, switching, firewall, security services, content filtering, and any/all other types of data access. Each customer side network system 101 is communicatively coupled to an access-layer switch 102 in the service provider network 103. The service provider network 103 may provide the following but not limited to: internet access, layer 2 access, routing, switching, firewall, security services, content filtering, and any/all other types of data access. In the service provider network 103 this may be a series of separate devices based on functionality and customer requirements. In this embodiment, the system facilitates communications 104 from the multiple customer side network systems 105 on the customer side into communications for delivery over a service provider network 103. The multiple systems 105 on the customer side may comprise but is not limited to file servers, wireless devices, workstations, any any/all devices connected to customer side network. In one embodiment, the communications 104 are customer internet traffic tagged with customer specific external VLAN ID (xx1). In this embodiment, the provider network 103 passes Customer Internal VLAN (xx2) tagged traffic 106 to customer edge and removes the VLAN tag. In this embodiment, the customer connects a secondary link to an internal network. At this point, the customer may provide additional routing, switching and firewall/security services before passing traffic to their internal network. In this embodiment, the system further comprises a plurality of access points 107 and wireless networks 107 provided by the service provider 103 and/or customer. The access points 107 are capable of passing traffic from the customer network 101 through the provider network 103 to the individual or plurality of customer's network devices 105 that are associated with/or to other network endpoints independent of the customer's network.

In FIG. 1, the customer wireless device 108 connects to publicly accessible Provider Wireless Access Point (AP) 107 via a Customer Specific SSID 109. The customer and/or service provider is able to provide wireless security. This wireless security may include but is not limited to a RADIUS Server, WPA/WPA2 Enterprise, WPA/WPA2 Consumer, Certificates, and/or other security methods. The Provider AP 107 is configured to assign traffic from the Customer Specific SSID 109 to a Customer Specific Internal VLAN tag 110. The Customer Specific Internal VLAN tagged traffic 110 is passed to a Service Provider Firewall. The service provider firewall may provide additional services such as Firewall/Security, Content Filtering, Intrusion Detection and/or Prevention; however, the invention is not limited to these services. In communication step 106, The Customer Specific Internal VLAN 110 is then passed through a series of switches 102 and/or routers, and finally stripped of the Customer Specific Internal VLAN tag 110 before it is handed off to a Customer Edge Device. The Customer may connect this directly to their internal devices (Switch, APs, Servers, Workstations, etc.) or they may connect it to a Firewall or Router to provide additional Routing, Firewall/Security, Content Filtering, Intrusion Detection and/or Prevention, etc. of their own before passing the traffic to their internal network.

The customer may connect to the service provider network 103 at any layer in the network topology including but not limited the access-layer switch, the edge switch, the core switch, or core router of the service provider.

The access-layer switch 102 can be employed in environment such as a single tenant, multi-tenant or multi-dwelling complex. The external interfaces in the access-layer switch can be based on any wired or wireless technology, for example but not limited to, technology that supports Ethernet MAC frame transport (e.g., xDSL, optical, 802.11a/ac/b/g/n, etc). The access layer switch 102 is content neutral and therefore inherently supports the delivery of multi-services, such as voice, data, video and any combination of these and alternative types of content. Additionally, the access-layer switch 102 supports QoS via mechanisms such as those based on the IEEE 802.1p or 802.1Q standards or IP-based TOS/DiffServ.

In one embodiment, the customer network systems 101 are VLAN network segments. Although network segments are shown to be VLAN network segments, the present invention is not limited to VLAN network segments. Other types of network segments such as a LAN using transparent LAN services (“TLS”), frame relay, or the like over a service provider network may also be employed. In an embodiment where a network segment implements TLS services, the network segment can be assigned a reserved identifier to implement the VLAN translation services. For example, a VLAN ID (“VID”) that is not within the allowable VID address space can be used for this purpose.

In one embodiment, during VLAN ID translation the VLAN ID on the customer side remains intact. Alternatively, the VLAN ID on the customer side may also undergo a transformation to help determine the particular VLAN ID to be used when the frame is transmitted over the service provider network.

In one embodiment, on the service provider side 103, unique VLAN IDs are maintained across the service provider network 103. Accordingly a Q-in-Q or other similar encapsulation process may be performed in the VLAN translation step to assign a new VLAN ID to the frame for transmission across the service provider network. This can be referred to as LAN-WAN translation since the VLAN ID for the network segment (e.g., LAN) is translated into a VLAN ID for the service provider network (e.g., WAN).

The particular LAN-WAN translation function can be set up administratively, and may include standard transformation techniques such as VLAN-in-VLAN or other similar encapsulation, which inserts an additional VLAN tag containing a transformed unique VLAN ID into the frame immediately after the source and destination address field. Additionally, a configurable Ether-type field may also be included in the inserted tag to improve interoperability with various WAN switches. Other VLAN ID translations can also be used. In one embodiment, additional control can be applied to manage the egress tagging behavior (e.g., tagged or untagged). For example, the translator should be configured for tagged egress operation on a trunk port where there may be an aggregation of frames from multiple customer VLANs. In an alternative embodiment, VLAN IDs from the customer side can be remapped to a VLAN ID for the network service provider side.

Furthermore, the invention may comprise a wireless network controller. The network controller can be on site or offsite. The invention may further comprise a standard LAN controller that is well understood in the art. The invention may further comprise a standard WAN controller that is well understood in the art. The invention may further comprise a cloud controller that is well understood in the art. In the preferred embodiment, the VLAN at the access point of a wireless network is tagged at the radio.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

1. A network with wireless capability comprising:
a service provider network communicatively coupled to an access-layer switch and a plurality of access points;
a customer network system communicatively coupled to the access-layer switch provided by the Service Provider; and
a plurality of access points wherein the access points are capable of passing traffic from the customer network through the service providers' network to the customers' network devices;
wherein the system facilitates communications from the multiple network systems on the customer side into communications for delivery over a service provider network.

2. The system of claim 1 wherein the access-layer switch is employed in a single tenant complex.

3. The system of claim 1 wherein the access-layer switch is employed in a multi-tenant complex.

4. The system of claim 1 wherein the access-layer switch is employed in a multi-dwelling complex.

5. The system of claim 1 wherein a customer connects to the service provider at the access-layer switch.

6. The system of claim 1 wherein a customer connects to the service provider at the core switch.

7. The system of claim 1 wherein a customer connects to the service provider at the core router of the service provider.

8. The system of claim 1 wherein the network systems are VLANs.

9. The system of claim 8 wherein unique VLAN IDs are maintained across the service provider network.

10. A network with wireless capability comprising:
a customer;
a service provider;
a service provider network communicatively coupled to an access-layer switch and a plurality of access points;
a customer network system communicatively coupled to the access-layer switch provided by the Service Provider; and
a plurality of access points wherein the access points are capable of passing traffic from the customer network through the service providers' network to the customers' network devices;
wherein the system facilitates communications from the multiple network systems on the customer side into communications for delivery over a service provider network.

11. The System of claim 1 wherein the access points are wireless networks.

12. The system of claim 10 wherein the access points are wireless networks.

13. The system of claim 8 wherein unique VLAN IDs are maintained across the service provider network.

14. The system of claim 8 wherein during VLAN ID translation the VLAN ID on the customer side remains intact.

15. The system of claim 8 wherein the VLAN ID on the customer side undergoes transformation.
